(19) United States
(12) Patent Application Publication
(10) Pub. No.: US 2025/0242742 A1
(43) Pub. Date: Jul. 31, 2025

(54) RECREATIONAL VEHICLE COMPRISING SLIDE OUT WITH ENTRY BEVEL AND COMPOSITE FLOORING CONFIGURATION

(71) Applicant: Thor Tech, Inc., Elkhart, IN (US)

(72) Inventors: Jonathan Brock, Warsaw, IN (US); Bradd Giggy, LaGrange, IN (US)

(73) Assignee: Thor Tech, Inc., Elkhart, IN (US)

(21) Appl. No.: 19/036,761

(22) Filed: Jan. 24, 2025

Related U.S. Application Data
(60) Provisional application No. 63/625,327, filed on Jan. 26, 2024.

(51) Int. Cl. B60P 3/34

(52) U.S. Cl. CPC B60P 3/34

(57) ABSTRACT

A recreational vehicle (RV) may include a chassis, at least one axle assembly, a vehicle body, and a slide out compartment. The slide out compartment may be integrated with the vehicle body, extendable to expand an interior volume of the vehicle body, and retractable over a body-side edge of the floor of the vehicle body to reduce an interior volume of the vehicle body. The slide out compartment may include a slide out floor assembly including an impact resistant sheet, a core floor component, a weather resistant sheet, and an entry bevel. The entry bevel may be positioned along an entry edge of the core floor component of the slide out compartment and may include a leading edge, a transitional surface, an angled contact surface, a sheet concealment ridge, an exterior sheet accommodating surface, and an anchoring tail.

### CROSS-REFERENCE TO RELATED APPLICATIONS

This application claims the benefit of U.S. Provisional Application Ser. No. 63/625,327, filed Jan. 26, 2024.

### BACKGROUND

The present disclosure relates to recreational vehicles. Specifically, the present disclosure relates to slide outs and composite floors of recreational vehicles.

### BRIEF SUMMARY

According to the subject matter of the present disclosure, slide out compartments are provided for recreational vehicles (RVs). Contemplated slide out compartments may include a slide out floor assembly with an entry bevel to transition the slide out compartment from an extended position to a retracted position and preserve the structural integrity of the slide out floor assembly.

Traditional slide out floor assemblies may be installed on an RV. However, as the slide out compartment transitions from the extended position to the retracted position, portions of the slide out floor may rip, tear, or otherwise deteriorate. In embodiments illustrated herein, an entry bevel is included on the slide out floor assembly of the slide out compartment such that the slide out floor assembly is adequately protected when moving from the extended position to the retracted position, or from the retracted position to the extended position. Moreover, the composite floors described herein provide for a stronger RV floor.

In accordance with one embodiment of the present disclosure, a recreational vehicle may include a chassis, at least one axle assembly, a vehicle body, and a slide out compartment. The vehicle body may include an interior space and a floor and is supported by the chassis. The at least one axle assembly may be coupled to the chassis and may provide motive support to the chassis. Moreover, the slide out compartment may be integrated with the vehicle body, may be extendable to expand an interior volume of the vehicle body, and may be retractable over a body-side edge of the floor of the vehicle body to reduce the interior volume of the vehicle body. The slide out compartment may include a slide out floor assembly including an impact resistant sheet, a core floor component, a weather resistant sheet, and an entry bevel. The core floor component of the slide out floor assembly may include an interior-facing surface and an exterior-facing surface and may be sandwiched between the impact resistant sheet and the weather resistant sheet. The entry bevel may be positioned along an entry edge of the core floor component of the slide out compartment and may include a leading edge, a transitional surface, an angled contact surface, a sheet concealment ridge, an exterior sheet accommodating surface, and an anchoring tail. The transitional surface of the entry bevel may extend from the leading edge of the entry bevel towards the interior-facing surface of the core floor component and may lie in a common plane with the interior-facing surface of the core floor component. The impact resistant sheet may extend over the transitional surface of the entry bevel and the interior-facing surface of the core floor component. The angled contact surface of the entry bevel may extend from the leading edge of the entry bevel towards the exterior-facing surface of the core floor component. The exterior sheet accommodating surface of the entry bevel may extend from the sheet concealment ridge of the entry bevel towards the exterior-facing surface of the core floor component and may be offset from the exterior-facing surface of the core floor component by a thickness dimension of the anchoring tail of the entry bevel. The anchoring tail may extend from, and may lie in a common plane with, the exterior sheet accommodating surface of the entry bevel and may be sandwiched between the core floor component and the weather resistant sheet. The weather resistant sheet may extend over the exterior sheet accommodating surface of the entry bevel, the anchoring tail of the entry bevel, and the exterior-facing surface of the core floor component.

In accordance with another embodiment of the present disclosure, a slide out floor assembly may include an impact resistant sheet, a core floor component, a weather resistant sheet, and an entry bevel. The core floor component of the slide out floor assembly may include an interior-facing surface and an exterior-facing surface and may be sandwiched between the impact resistant sheet and the weather resistant sheet. The entry bevel may be positioned along an entry edge of the core floor component and may include a leading edge, a transitional surface, an angled contact surface, a sheet concealment ridge, an exterior sheet accommodating surface, and an anchoring tail. The transitional surface of the entry bevel may extend from the leading edge of the entry bevel towards the interior-facing surface of the core floor component and may lie in a common plane with the interior-facing surface of the core floor component. The impact resistant sheet may extend over the transitional surface of the entry bevel and the interior-facing surface of the core floor component. The angled contact surface of the entry bevel may extend from the leading edge of the entry bevel towards the exterior-facing surface of the core floor component. The exterior sheet accommodating surface of the entry bevel may extend from the sheet concealment ridge of the entry bevel towards the exterior-facing surface of the core floor component and may be offset from the exterior-facing surface of the core floor component by a thickness dimension of the anchoring tail of the entry bevel. The anchoring tail may extend from, and may lie in a common plane with, the exterior sheet accommodating surface of the entry bevel and may be sandwiched between the core floor component and the weather resistant sheet. The weather resistant sheet may extend over the exterior sheet accommodating surface of the entry bevel, the anchoring tail of the entry bevel, and the exterior-facing surface of the core floor component.

In accordance with another embodiment of the present disclosure, a recreational vehicle may include a slide out compartment including a core floor component, a weather resistant sheet, and an entry bevel. The core floor component may include an interior-facing surface and an exterior-facing surface and the weather resistant sheet may be positioned over the exterior-facing surface of the core floor component. The entry bevel may be positioned along an entry edge of the core floor component and may include a leading edge, a transitional surface, an angled contact surface, a sheet concealment ridge, and an anchoring tail. The transitional surface of the entry bevel may extend from the leading edge of the entry bevel towards the interior-facing surface of the core floor component. The angled contact surface of the entry bevel may extend from the leading edge of the entry bevel towards the exterior-facing surface of the core floor component. The anchoring tail may be sandwiched between the core floor component and the weather resistant sheet. The weather resistant sheet may extend from the sheet concealment ridge, over the anchoring tail of the entry bevel and the exterior-facing surface of the core floor component.

In accordance with another embodiment of the present disclosure, a recreational vehicle may include a chassis, at least one axle assembly, a vehicle body, and a composite floor. The vehicle body and the composite floor may be supported by the chassis and the axle assembly may be coupled to the chassis and may provide motive support to the chassis. The composite floor may include an impact resistant sheet, a core floor component, a planar strength member, and a weather resistant sheet. The core floor component may include an interior-facing surface, an exterior-facing surface, a skeletal framework, a plurality of foam core inserts, and a plurality of contained framework cells. Moreover, the core floor component may be sandwiched between the impact resistant sheet and the planar strength member. The weather resistant sheet may be positioned on an exterior surface of the planar strength member. Each contained framework cell may be bounded volumetrically by frame segments of a closed frame section, portions of the impact resistant sheet, and portions of the planar strength member. Each contained framework cell may be packed with one or more of the foam core inserts and the foam core inserts within each cell may collectively occupy a substantial entirety of the contained framework cell.

Although the concepts of the present disclosure are described herein with primary reference to RVs, it is contemplated that the concepts will enjoy applicability to any vehicle. For example, and not by way of limitation, it is contemplated that the concepts of the present disclosure will enjoy applicability to cars, trucks, tractor-trailers, or any other suitable vehicle.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1A is a schematic illustration of a recreational vehicle with a slide out compartment in an extended position, according to one embodiment of the present disclosure;

FIG. 1B is a schematic illustration of a recreational vehicle with a slide out compartment in a retracted position, according to one embodiment of the present disclosure;

FIG. 2 illustrates a slide out floor assembly, according to the present disclosure;

FIG. 3 illustrates a skeletal framework of the slide out floor assembly of FIG. 2, according to one embodiment of the present disclosure; and

FIG. 4 is cross-sectional side view of a slide out floor assembly including an entry bevel, according to one embodiment of the present disclosure;

FIG. 5 is a side view of an entry bevel, according to one embodiment of the present disclosure;

FIG. 6A is a schematic illustration of a skeletal framework of a composite floor, according to one embodiment of the present disclosure;

FIG. 6B is a schematic illustration of a closed frame section of a skeletal framework of a composite floor, according to one embodiment of the present disclosure;

FIG. 7 is a is cross-sectional side view of a composite floor, according to one embodiment of the present disclosure; and

FIG. 8 illustrates the joinder of an end wall and a slide out floor of a slide out compartment, according to one embodiment of the present disclosure.

### DETAILED DESCRIPTION

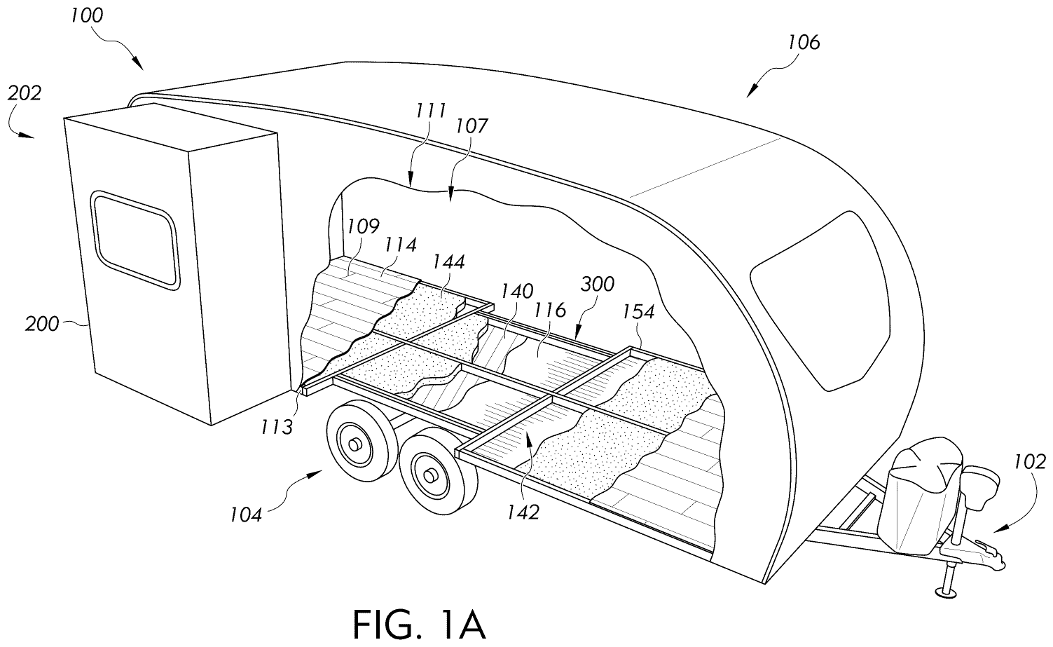

FIGS. 1A and 1B illustrate a recreational vehicle (RV) 100 comprising a chassis 102, at least one axle assembly 104, a vehicle body 106, and a slide out compartment 200. The vehicle body 106 includes an interior space 107 and a floor 109 that is supported by the chassis 102. The axle assembly 104 is coupled to the chassis 102 and provides motive support to the chassis 102.

The recreational vehicle 100 may be a towable trailer or a motorized recreational vehicle, such as a motorhome, a fifth wheel camper, a toy hauler, a travel trailer, a teardrop camper, a tiny trailer, a pop-up camper, or any other vehicle. The axle assembly 104 may be a driven or non-driven axle assembly.

The slide out compartment 200 is integrated with the vehicle body 106 and the slide out compartment 200 is extendable to expand an interior volume 111 of the vehicle body 106 (such as in an extended position 202, as depicted in FIG. 1A) and retractable over a body-side edge 113 of the floor 109 of the vehicle body 106 to reduce the interior volume 111 of the vehicle body 106 (such as in an retracted position 204, as depicted in FIG. 1B).

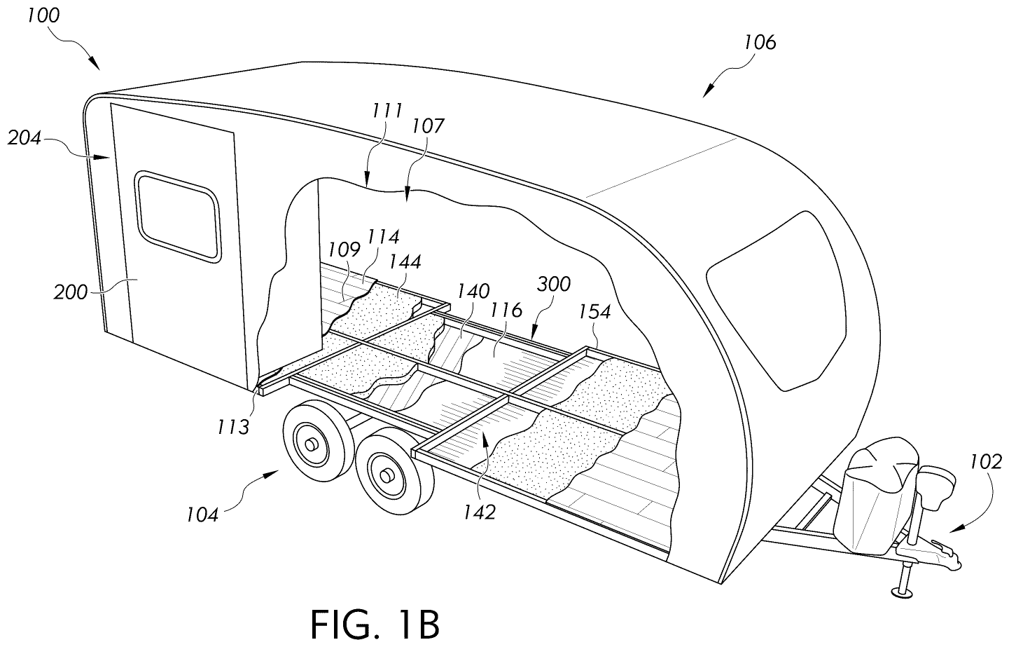

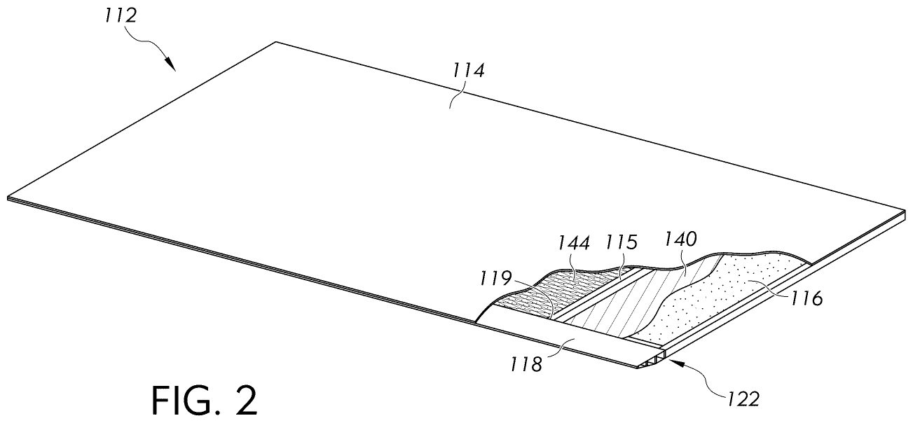

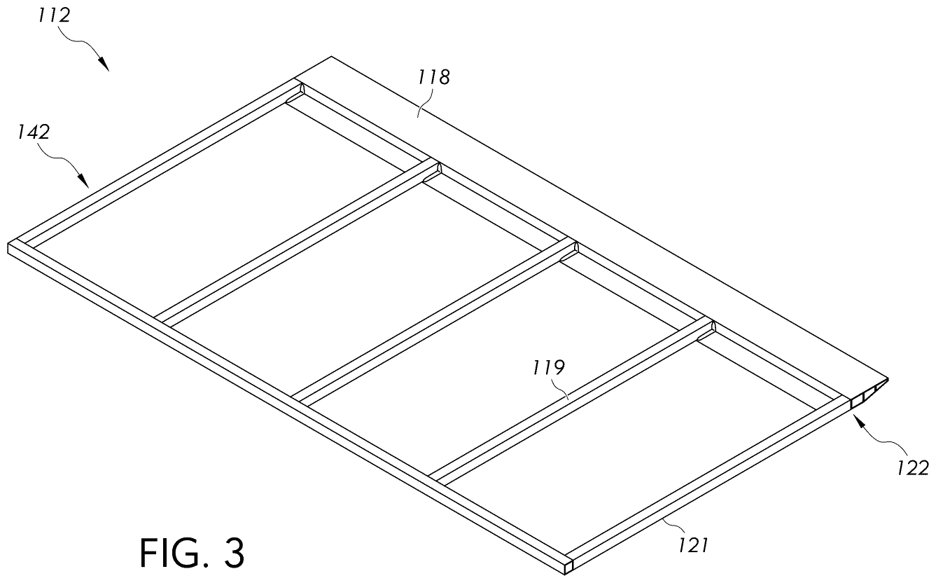

Now FIG. 2, the slide out compartment 200 includes a slide out floor assembly 112 including an impact resistant sheet 114, a core floor component 115, a weather resistant sheet 116, and an entry bevel 118. The core floor component 115 includes an interior-facing surface 119 and an exterior-facing surface 121. Moreover, the core floor component 115 may be sandwiched between the impact resistant sheet 114 and the weather resistant sheet 116 (as further depicted in FIG. 4). The entry bevel 118 may be positioned along an entry edge 122 of the core floor component 115 of the slide out compartment 200.

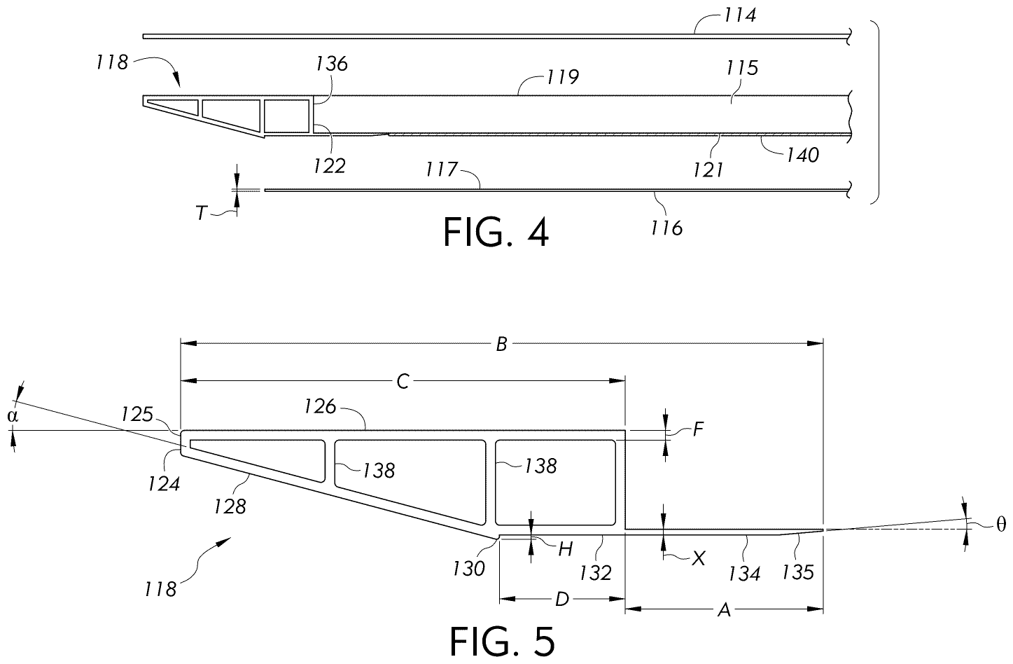

Referring now to FIG. 5, the entry bevel 118 includes a leading edge 124, a transitional surface 126, an angled contact surface 128, a sheet concealment ridge 130, an exterior sheet accommodating surface 132, and an anchoring tail 134. The transitional surface 126 of the entry bevel 118 extends from the leading edge 124 of the entry bevel 118 towards the interior-facing surface 119 of the core floor component 115 (as depicted in FIG. 4) and lies in a common plane with the interior-facing surface 119 of the core floor component 115.

Referring to FIG. 4, the impact resistant sheet 114 extends over the transitional surface 126 of the entry bevel 118 and the interior-facing surface 119 of the core floor component 115. Moreover, the angled contact surface 128 of the entry bevel 118 extends from the leading edge 124 of the entry bevel 118 towards the exterior-facing surface 121 of the core floor component 115. The exterior sheet accommodating surface 132 of the entry bevel 118 extends from the sheet concealment ridge 130 of the entry bevel 118 towards the exterior-facing surface 121 of the core floor component 115 and is offset from the exterior-facing surface 121 of the core floor component 115 by a thickness dimension of the anchoring tail 134 of the entry bevel 118.

The anchoring tail 134 extends from, and lies in a common plane with, the exterior sheet accommodating surface 132 of the entry bevel 118 and is sandwiched between the core floor component 115 and the weather resistant sheet 116. The anchoring tail 134 may also lie in a plane that is parallel to the transitional surface 126 of the entry bevel 118. Moreover, the weather resistant sheet 116 extends over the exterior sheet accommodating surface 132 of the entry bevel 118, the anchoring tail 134 of the entry bevel 118, and the exterior-facing surface 121 of the core floor component 115.

The slide out compartment 200 may be in the extended position 202 (as depicted in FIG. 1A), the retracted position 204 (as depicted in FIG. 1B), or a position there between. When in the retracted position, the slide out floor assembly 112 of the slide out compartment 200 may lie in a common plane with the floor 109 of the RV 100. The slide out compartment 200 in the extended position 202 gives more space to occupants of the recreational vehicle 100 by extending the interior volume 111 of the vehicle body 106. When retracted from the extended position 202, the angled contact surface 128 of the entry bevel 118 is positioned to engage the body-side edge 113 of the floor 109 of the vehicle body 106.

Specifically, the angled contact surface 128 of the entry bevel 118 causes the slide out floor assembly 112 to ride over the floor 109 of the vehicle body 106 when the slide out compartment 200 is moved from the extended position 202 to the retracted position 204. Moreover, when the slide out compartment 200 is in the extended position 202, the impact resistant sheet 114 extending over the transitional surface 126 of the entry bevel 118 is positioned to lie in a common plane with the floor 109 of the vehicle body 106. The impact resistant sheet 114 lying in a common plane of the floor 109 of the vehicle body 106 prevents a ridge/lip from existing in the interior space 107 of the RV 100, yielding a smooth transition between the floor 109 and the slide out compartment 200.

Referring now to FIG. 5, in embodiments, the angled contact surface 128 of the entry bevel 118 extends from the leading edge 124 of the entry bevel 118 to the sheet concealment ridge 130 of the entry bevel 118. As noted hereinabove, the angled contact surface 128 of the entry bevel 118 engages the body-side edge 113 of the floor 109 to bring the slide out compartment 200 over the floor 109 when the slide out compartment 200 is moved from the extended position 202 to the retracted position 204. The angled contact surface 128 of the entry bevel 118 forms a contact angle α relative to the transitional surface 126 of the entry bevel. In embodiments, the contact angle α may be between about 5 degrees and about 30 degrees, or about 15 degrees±10%.

As the angled contact surface 128 of the entry bevel 118 engages the body-side edge 113 of the floor 109, the entry bevel 118 may experience pressure/stresses. As such, to reinforce the entry bevel 118 and prevent collapsing of the entry bevel 118, the entry bevel 118 may include contact supports 138. In embodiments, the angled contact surface 128 of the entry bevel 118 may be supported via the contact supports 138 extending from the angled contact surface 128 to the transitional surface 126 of the entry bevel 118. The angled contact surface 128 of the entry bevel 118 may be supported via one, two, three, four, or more contact supports 138 extending from the angled contact surface 128 to the transitional surface 126 of the entry bevel 118.

In general, as slide out compartments move from the extended position to the retracted position, components around the entry bevel may deteriorate or damage as the bevel engages the floor of the RV. Specifically, layers attached to the bevel may peel or rip as the bevel engages the floor of the RV. Embodiments of the current disclosure yield rugged slide out compartments with an entry bevel that reduces/eliminates peeling and ripping of the floor of the slide out compartment, resulting in longer lasting and more durable slide out floors.

Referring again to FIG. 5, the sheet concealment ridge 130 and the exterior sheet accommodating surface 132 may protect the weather resistant sheet 116 from peeling as the slide out compartment 200 is transitioned from the extended position 202 to the retracted position 204. In embodiments, a height H of the sheet concealment ridge 130 relative to the exterior sheet accommodating surface 132 is greater than a thickness T of the weather resistant sheet 116. In further embodiments, the height H of the sheet concealment ridge 130 may be about 1 millimeter greater than the thickness T of the weather resistant sheet 116. Generally, the thickness T of the weather resistant sheet 116 closely approximates, but is slightly less than the height H of the sheet concealment ridge 130. In some embodiments, the difference between the height H of the sheet concealment ridge 130 and the thickness T of the weather resistant sheet 116 less than about 2 millimeters, less than about 1.5 millimeters, less than about 1.2 millimeters, less than about 0.5 millimeters, or less than about 0.3 millimeters. In further embodiments, the height H of the sheet concealment ridge 130 and the thickness T of the weather resistant sheet 116 may be equal to one another.

In the aforementioned embodiments, the sheet concealment ridge 130 prevents the weather resistant sheet 116 from coming into contact with the body-side edge 113 of the floor 109 of the RV 100. As such, the embodiments described herein provide for a more rugged and resilient slide out compartment, as embodiments of the present disclosure prevent peeling/ripping of the weather resistant sheet 116.

The anchoring tail 134 of the entry bevel provides for a stronger connection between the entry bevel 118 and the core floor component 115. Specifically, the anchoring tail 134 provides for more surface area for the entry bevel 118 to be connected to the core floor component 115 of the slide out floor assembly 112, preventing separation of the entry bevel 118 and core floor component 115. Moreover, the anchoring tail 134 of the current disclosure adds minimal thickness to the slide out floor assembly 112, yielding a compact floor design.

Still referring to FIGS. 4 and 5, in embodiments, the anchoring tail 134 of the entry bevel 118 is secured to exterior-facing surface 121 of the core floor component 115 through adhesive, screws, bolts, or any other suitable means of securement. The anchoring tail 134 of the entry bevel 118 may extend from the exterior sheet accommodating surface 132 and terminate at a tapered terminal portion 135 of the anchoring tail 134. The tapered terminal portion 135 provides for a smooth transition between the anchoring tail 134 and the weather resistant sheet 116, such that the connection between the anchoring tail 134 and the weather resistant sheet 116 is stronger compared to embodiments that do not include the tapered terminal portion 135 on the anchoring tail 134. The tapered terminal portion 135 of the anchoring tail 134 may form a contact angle θ relative to the core floor component 115 of about 5 degrees±10%.

In embodiments, a thickness dimension X of the anchoring tail 134, orthogonal to a major face 117 of the weather resistant sheet 116, is less than respective thickness dimensions of a frame portion F the transitional surface 126 of the entry bevel 118 in the same direction. The thickness dimension X of the anchoring tail 134 may be between about 40% thinner and about 80% thinner or between about 50% thinner±10% and about 70%±10% thinner than the frame portion F the transitional surface 126. In embodiments, the thickness dimension X of the anchoring tail 134 may be 1 millimeter, 1.5 millimeter, or 2 millimeters thick. As noted above, the thin anchoring tail 134 decreases an overall thickness of the slide out floor assembly 112, allowing for a compact structure that more easily slides over the floor 109 of the RV 100. The thickness dimensions of the frame portion F may be 2.5 millimeters±10%.

In embodiments, the anchoring tail 134 may define a tail length A from the exterior sheet accommodating surface 132 to the tapered terminal portion 135. The entry bevel 118 may define a body length B along a dimension parallel to the transitional surface 126 of the entry bevel 118. The body length B may encompass a transitional surface length C of the transitional surface 126 and the tail length A of the anchoring tail 134. The tail length B may be defined relative to the body length B. For example, in embodiments, the tail length A may be at least about 25% of the body length B, at least about 30% of the body length B, or at least about 40% of the body length B. As such, in embodiments, the tail length A of the anchoring tail 134 may be less than the transitional surface length C of the transitional surface 126.

In further embodiments, the exterior sheet accommodating surface 132 may define a surface length D from the sheet concealment ridge 130 to the anchoring tail 134, along a dimension parallel to the transitional surface 126 of the entry bevel 118. In such embodiments, the tail length A may be greater than the surface length D. The tail length A and the surface length D, combined may make up a percentage of the body length B. In embodiments, the tail length A and the surface length D may make up between about 35% and about 65% of the body length B or about 40% and about 60% of the body length B.

As noted above, the tail length A, body length B, transitional surface length C, and the surface length D may be defined relative to one another. Moreover, in embodiments, the tail length A may be about 50 millimeters±10%. The body length B may be about 165 millimeters±10%. The transitional surface length C may be about 115 millimeters±10%. The surface length D may be about 30 millimeters±10%. It should be understood that all exemplary lengths/dimensions described herein are exemplary in nature, and embodiments described herein may vary in length/dimensions.

Referring again to FIGS. 4 and 5, the entry bevel 118 may further include an abutment surface 136 that abuts the entry edge 122 of the core floor component 115. The abutment surface 136 may be welded to the entry edge 122 of the core floor component 115. In further embodiments, the abutment surface 136 may be secured to the entry edge 122 of the core floor component 115 through the use of adhesives, screws, or any other suitable means of securement.

As noted hereinabove, the entry bevel 118 further includes the leading edge 124. In embodiments, the leading edge 124 of the entry bevel 118 is truncated to form a leading edge surface 125 extending from the transitional surface 126 to the angled contact surface 128 of the entry bevel 118. The distance from the transitional surface 126 to the angled contact surface 128 along the leading edge surface 125 may be less than 1 centimeter±10%, or more preferably between about 6 millimeters and about 7 millimeters. The leading edge surface 125 may be a variety of shapes. In embodiments, the leading edge surface 125 may be planar (as depicted) or rounded.

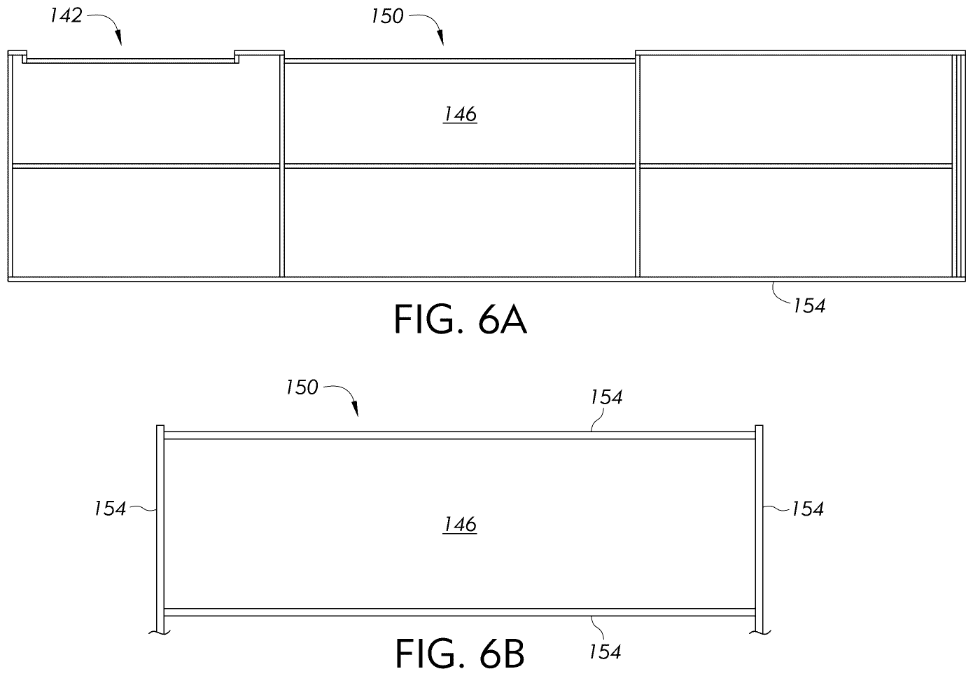

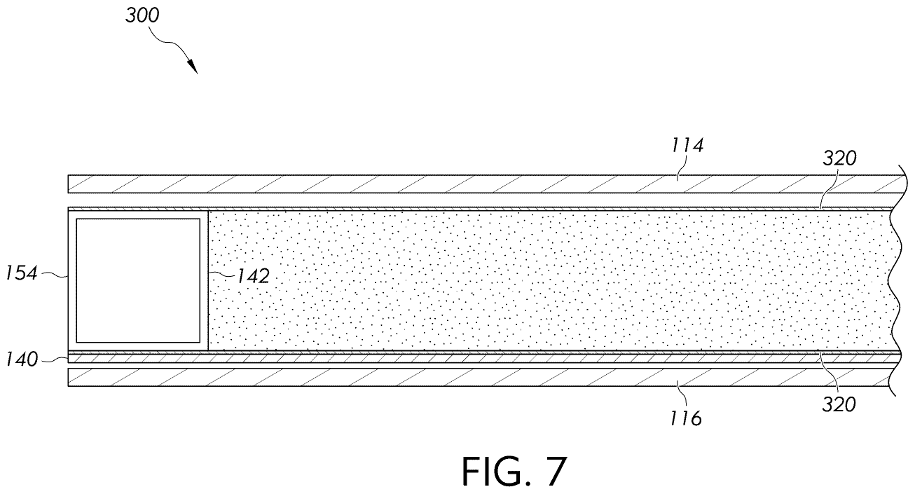

FIGS. 6A and 6B depict the core floor component 115. In embodiments, the core floor component 115 may include a skeletal framework 142, a plurality of foam core inserts 144, and a plurality of contained framework cells 146. Specifically, FIG. 6A depicts a the plurality of contained framework cells 146, while FIG. 6B depicts a single contained framework cell 146. FIG. 7 depicts a foam core insert 144 within the core floor component 115. Each contained framework cell 146 may be bounded volumetrically by frame segments 154 of a closed frame section 150, portions of the impact resistant sheet 114, portions of a planar strength member 140 (explained further below) and portions of the weather resistant sheet 116. Individual ones of the foam core inserts 144 may be large enough to frictionally engage at least two parallel frame segments 154 of a closed frame section 150 of the skeletal framework 142. Each contained framework cell 146 may be packed with one or more of the foam core inserts 144 and the foam core inserts 144 within each cell may collectively occupy a substantial entirety of the contained framework cell 146.

Referring again to FIG. 4, the impact resistant sheet 114 may extend from the leading edge 124 of the entry bevel 118, over the transitional surface 126 of the entry bevel 118, and over the interior-facing surface 119 of the core floor component 115. Further depicted in FIG. 4, in embodiments, the weather resistant sheet 116 may extend from the sheet concealment ridge 130 and over the exterior-facing surface 121 of the core floor component 115.

The impact resistant sheet 114 and the weather resistant sheet 116 may be fiberglass reinforced polymer sheets. The fiber content of the impact resistant sheet 114 and the weather resistant sheet 116 may be between about 35 wt. % and about 70 wt. %. The impact resistant sheet 114 may comprise a greater fiber content than the weather resistant sheet 116. The impact resistant sheet 114 and the weather resistant sheet 116 may define a fiber content A, representing a difference between a fiber wt. % content of the impact resistant sheet 114 and a fiber wt. % content of the weather resistant sheet 116 that may be at least 20 wt. %. The impact resistant sheet 114 may comprise a fiber content of about 60 wt. % and the weather resistant sheet 116 may comprise a fiber content of about 40 wt. %.

It should be noted that the composition weather resistant sheet 116 may differ from the impact resistant sheet 114. Some of the functional requirements of the weather resistant sheet 116 differ from those of the impact resistant sheet 114. For instance, the weather resistant sheet 116 will be exposed to the exterior environment and, as such, may be more environmentally durable than the impact resistant sheet 114.

Referring again to FIG. 4, the slide out floor assembly 112 may further include a planar strength member 140 sandwiched between the weather resistant sheet 116 and the core floor component 115. The planar strength member 140 may extend over the exterior-facing surface 121 of the core floor component 115 and the anchoring tail 134 of the entry bevel 118, or the planar strength member 140 may extend over the exterior-facing surface 121 of the core floor component 115 and terminate at the tapered terminal portion 135 of the anchoring tail 134. As depicted in FIG. 7, the planar strength member 140 may extend over the skeletal framework 142, the plurality of foam core inserts 144, and the plurality of contained framework cells 146 of the core floor component 115. As explained further below, the planar strength member 140 may be connected to the core floor component 115 and the weather resistant sheet 116 through the use of adhesives or a suitable fastener.

The planar strength member 140 provides mechanical strength and rigidity to the slide out floor assembly 112, such that the slide out floor assembly 112 bends less as the slide out compartment 200 is moved from the extended position 202 to the retracted position 204. The planar strength member 140 may be a composite material. Specifically, the planar strength member 140 may be a lightweight, durable, and rigid composite material. The planar strength member 140 may be a polypropylene-based composite material. The planar strength member 140 may also be either a polyethylene-based material or an organic material. The planar strength member 140 may also be defined relative to the impact resistant sheet 114. For example, the planar strength member 140 may include an area density that is 40% to 60% less dense than an area density of the impact resistant sheet 114. Moreover, the planar strength member may be between about 2 millimeters and about 3 millimeters thick, or preferably about 2.7 millimeters thick±10%.

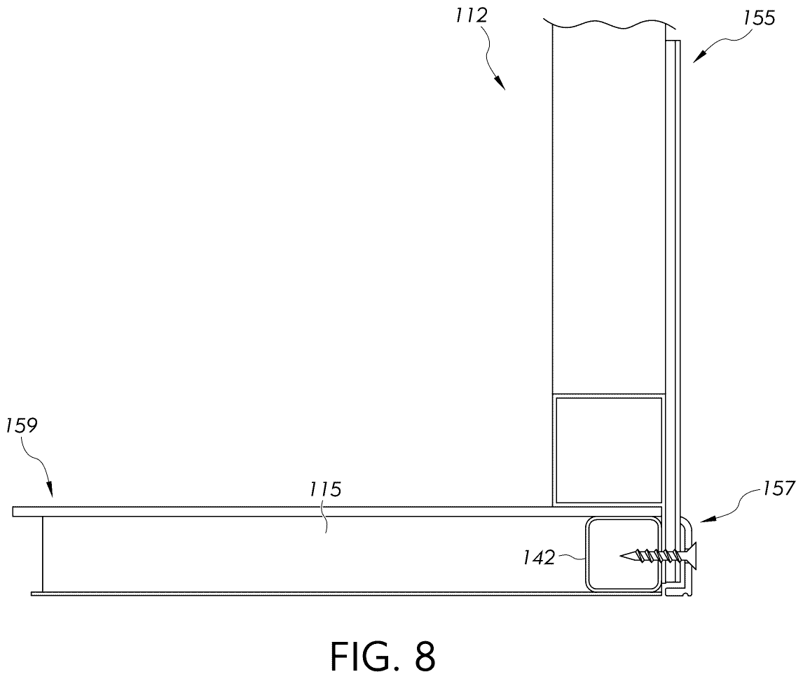

FIG. 8 illustrates the manner in which a slide end wall 155 of the slide out compartment 200 may be secured to a slide out floor 159 of the slide out floor assembly 112 including the skeletal framework 142 of the core floor component 115. More specifically, the slide end wall 155 is constructed with its own aluminum frame, which includes a P tube flange 157 along its bottom edge. The slide end wall 155 can be secured to the slide out floor along its bottom edge with suitably positioned fasteners extending through the extending portion of the P tube flange 157 into the aluminum frame (e.g., the skeletal framework 142) of the slide out floor 159, as is illustrated in FIG. 8. Notably, this P-rail fastening technique eliminates the need for fastening through the bottom of the slide out floor 159, avoiding the use of fasteners that would cause wear as the slide out compartment 200 is moved between the extended position 202 and the retracted position 204, and thus reducing damage associated with such bottom fasteners.

Referring now to FIG. 7, embodiments of the present disclosure also include an RV 100 including a composite floor 300. The composite floor 300 includes the impact resistant sheet 114, the core floor component 115, the planar strength member 140, and the weather resistant sheet 116. The weather resistant sheet 116 is positioned on an exterior surface of the planar strength member 140 and the core floor component 115 is sandwiched between the impact resistant sheet 114 and the planar strength member 140. Moreover, the core floor component 115 of the composite floor 300 includes the skeletal framework 142, a plurality of foam core inserts 144, and a plurality of contained framework cells 146. Each contained framework cell 146 may be bounded volumetrically by frame segments 154 of a closed frame section 150, portions of the impact resistant sheet 114, and portions of the planar strength member 140. Each contained framework cell 146 is packed with one or more of the foam core inserts 144 within each cell collectively to occupy a substantial entirety of the contained framework cell 146.

Structural adhesive 320 may be arranged to bond the skeletal framework 142, the foam core inserts 144, the impact resistant sheet 114, the weather resistant sheet 116, and the planar strength member 140 as a structurally integrated composite floor 300 where a force exerted on the impact resistant sheet 114 in a direction of a contained framework cell 146 encounters resistance that may be collectively attributable to one or more of the foam core inserts 144, one or more of the frame segments 154 of the skeletal framework 142, impact resistant sheet 114, planar strength member 140, and the weather resistant sheet 116, such that a collective modulus of elasticity (MOE) of the composite floor 300 comprises modulus components that may be attributable to the skeletal framework 142, the foam core inserts 144, the impact resistant sheet 114, the planar strength member 140, and the weather resistant sheet 116.

The collective MOE of the composite floor 300 may be between about be between about 400 ksi (2758 MPa) and about 750 ksi (5171 MPa). The collective MOE of the composite floor 300 may be about 575 ksi (3965 MPa)+10%.

Referring now to FIGS. 2A, and 2B, a majority of the closed frame sections 150 of the skeletal framework 142 comprise a planar area of between approximately 1.5 m² and approximately 3.5 m², which is significantly larger than would be available in an aluminum frame composite floor constructed in a different manner, using different materials, like thin plywood and relatively low density foam. Although larger area sections 150 are contemplated, typically, the closed frame sections 150 of the skeletal framework 142 will comprise a maximum planar area of less than approximately 6.0 m²±10%. Similarly, although smaller area sections are contemplated, typically, a majority of the closed frame sections 150 of the skeletal framework 142 will comprise a planar area that exceeds approximately 1.0 m²±10%.

A majority of the closed frame sections 150 of the skeletal framework 142 may include an unsupported longitudinal span of between approximately 1.5 meters and approximately 4.0 meters, which is significantly larger than would be available in an aluminum frame composite floor constructed in a different manner, using different materials, like thin plywood and relatively low density foam. Although larger spans are contemplated, typically, the closed frame sections 150 of the skeletal framework 142 will comprise a maximum unsupported longitudinal span of less than approximately 5.0 meters±10%. Similarly, although smaller spans are contemplated, a majority of the closed frame sections 150 of the skeletal framework 142 will comprise a minimum unsupported longitudinal span that exceeds approximately 1.0 meter±10%. As used herein, the term “longitudinal” is used to indicate the direction parallel to the longest pair of frame segments 154 in a particular closed frame section 150.

A plurality of the plurality of closed frame sections 150 may lie in a common plane. At least one additional closed frame section 150 may lie in a plane parallel to the common plane. The composite floor 300 may include a plurality of closed frame sections 150 and at least one open frame section.

Each of the plurality of foam core inserts 144 may include a density of at least about 30 kg/m³±10%. In some embodiments, each of the plurality of foam core inserts 144 includes a density of between about 30 kg/m³±10% and about 50 kg/m³±10%. Each of the plurality of foam core inserts 144 may frictionally engage at least two pairs of parallel frame segments 154 of a closed frame section 150 of the skeletal framework 142. Each contained framework cell 146 may be packed with a single foam core insert 144 that occupies a substantial entirety of the contained framework cell 146. Each contained framework cell 146 may be packed with a plurality of foam core inserts 144 that collectively occupy a substantial entirety of the contained framework cell 146. A foam thickness defined by the one or more foam core inserts 144 packed in a contained framework cell 146 may be equal to a frame thickness of the frame segments 154 of the closed frame section 150 bounding the contained framework cell 146. A foam thickness defined by the one or more foam core inserts 144 packed in a contained framework cell 146 may be greater than or less than a frame thickness of the frame segments 154 of the closed frame section 150 bounding the contained framework cell 146.

In some embodiments, each of the plurality of foam core inserts 144 may be sized to fit into a closed frame section 150 of the skeletal framework 142, or, in the alternative, each of the plurality of foam core inserts 144 may be formed in-situ in each closed frame section 150 of the skeletal framework 142.

Again referring to FIG. 7, the structural adhesive 320 may be arranged to bond the skeletal framework 142, the foam core inserts 144, the impact resistant sheet 114 and the planar strength member 140 to define a total composite floor 300 thickness. The impact resistant sheet 114 and the weather resistant sheet 116 may account for less than 20% of the total composite floor 300 thickness. The planar strength member 140 may account for less than 10% of the total composite floor 300 thickness. The weather resistant sheet 116 may be characterized by an average sheet thickness that is less than an average sheet thickness of the impact resistant sheet 114 and by an area density that is less than 50% of an area density of the impact resistant sheet 114.

The sheet thickness of the impact resistant sheet 114 may be 3.5 mm±20%. The sheet thickness of the weather resistant sheet 116 may be 1.0 mm±10%. The sheet thickness of the planar strength member 140 may be 2.7 mm±20%. The area density of the impact resistant sheet 114 may be 2850 g/m²±10%. The area density of the weather resistant sheet 116 may be 1000 g/m²±10%. The area density of the planar strength member 140 may be 1,300 g/m²±10%.

The impact resistant sheet 114 has a relatively high compression strength and point load characteristics. The impact resistant sheet 114 is suitable for supporting interior components of a RV 100 and heavy foot traffic. In some embodiments, the impact resistant sheet 114 may be a multi-layered, fiber-reinforced laminate including a first layer fabricated from a thermoplastic composite comprising polypropylene resin reinforced with continuous bi-directional glass fibers, a second layer fabricated from a thermoplastic composite comprising polypropylene resin reinforced with short strand X-Y-Z oriented glass fibers that may be weaved and needled to orient the glass fibers along the three-dimensional axes, a third layer like the first layer, and a woven, adhesion-promoting scrim layer or polyurethane film, which may be adhered to the foam core inserts 144. The scrim layer or polyurethane film may be provided in a variety of forms including, for example, a resin-impregnated non-woven mat of randomly-oriented fibers. The fibers may be carbon fibers, glass fibers, or synthetic resin fibers. For example, some synthetic fibers that may be used include aramid fibers. The fibers of the scrim layer may also be inorganic fibers such as metal fibers. For example, some metal fibers that may be used include aluminum fibers or titanium fibers.

It should be noted that the composition of the weather resistant sheet 116, the impact resistant sheet 114, and the planar strength member 140 may differ from one another. Some of the functional requirements of the weather resistant sheet 116 differ from those of the impact resistant sheet 114 and the planar strength member 140. For instance, the weather resistant sheet 116 will be exposed to the exterior environment and, as such, may be more environmentally durable than the impact resistant sheet 114. In some embodiments, the weather resistant sheet 116 may comprise a single polypropylene resin layer reinforced with long strand glass fibers and an adhesion-promoting scrim layer or polyurethane film between the reinforced resin layer and the foam core inserts 144. The weather resistant sheet 116 may also be provided with a thin protective film on its exterior-facing side to enhance resistance to moisture and other environmental elements.

Again referring to FIG. 7, the structural adhesive 320 may comprise continuous or discontinuous layers of adhesive between the skeletal framework 110 and the foam core inserts 144 and (i) the impact resistant sheet 114, (ii) the planar strength member 140, (iii) the weather resistant sheet 116, or (iv) any combination of (i)-(iii).

It is envisioned that, in some embodiments, the composite floor 300 may be bonded with or without the presence additional intervening materials arranged between the impact resistant sheet 114 and the foam core inserts 144, as well as between the planar strength member 140 and the foam core inserts 144. It is envisioned that such additional intervening materials may further promote adhesion, further enhance structural integrity, or serve any other purpose. Adhesive or any other additional intervening materials may also be positioned between the planar strength member 140 and the weather resistant sheet 116.

With reference to FIGS. 2A and 2B, in another embodiment, a method of making a composite floor 300 includes forming a skeletal framework 142 by assembling a plurality of closed frame sections 150 defined by frame segments 154, inserting one or more foam core inserts 144 into each of the closed frame sections of the skeletal framework 142, providing an impact resistant sheet 114, a planar strength member 140, and a weather resistant sheet 116, each sheet having an internal side and an external side, applying a structural adhesive 320 to the internal side of the impact resistant sheet 114 and contacting the impact resistant sheet 114 with the skeletal framework 142 and foam core inserts 144, applying the structural adhesive 320 to the internal side of the planar strength member 140 and contacting the planar strength member 140 with the skeletal framework 142 and foam core inserts 144, enclosing a composite floor assembly comprising the skeletal framework 142, foam core inserts 144, structural adhesive 320, impact resistant sheet 114, planar strength member 140, and weather resistant sheet 116 in a vacuum bag assembly, evacuating the vacuum bag assembly of air to compress the composite floor assembly 300, maintaining a vacuum environment in the vacuum bag assembly to bond each of the impact resistant sheet 114 and the planar strength member to the skeletal framework 142 and foam core inserts 144, returning air to the vacuum bag assembly, and removing the composite floor 108 from the vacuum bag assembly. The method may further include applying the structural adhesive 320 to the exterior side of the planar strength member 140 and contacting the planar strength member 140 with the weather resistant sheet 116.

For the purposes of defining and describing the present invention, it is noted that the impact resistant sheet 114 is “impact resistant” in the sense that it is sufficiently rigid to protect the foam core inserts 144 from the impact of foot traffic in the interior of the vehicle, without an accompanying layer of carpet padding, carpeting, or other interior floor components.

Each closed frame section 150 of the skeletal framework 142 is packed with at least one of the plurality of foam core inserts 144. For the purposes of the present disclosure it is noted that the term “packed” denotes the insertion of a foam core insert 144 into the volume of space defined by a closed frame section 150, with the understanding that the foam core insert 144 may occupy all or part of the volume, and may extend beyond the volume of the space defined by the closed frame section 150.

The adhesive is described herein as being “structural” only in the sense that it enables the other components of the composite floor 300 to contribute to the collective rigidity of the composite floor 300.

It should be understood that embodiments of the composite floor described herein may include any features of those described in U.S. Patent Publication No. 2020/0290685A1, the entirety of which is incorporated herein.

Although characteristics of the various components of the composite floor 300 have been described above, it should be understood that such characteristics may also apply to the components of the slide out floor assembly 112 of the slide out compartment 200 described above.

Collectively, the various features of the slide out floor and composite flooring configuration described herein provide a slide out configuration that extends and retracts reliably and does not retain water or degrade due to water exposure. Notably, the bottom layer material of the floor is laminated and more durable than conventional wraps or laminates, which is further strengthened by the planar strength member. In addition, the aluminum frame structure of the flooring configuration described herein provides for exceptional fastener retention for cabinets, tables, etc., with the opportunity to add an aluminum backer or other hardware for better fastening. The flooring configuration of the present disclosure also provides cost savings opportunities and significant weight reduction, e.g., approximately 97 pounds, as compared to a typical 31/32″ OSB slide floor. The entry bevel of the slide out compartment also provides for a more durable construction compared to conventional slide out mechanisms.

For the purposes of describing and defining the present invention, it is noted that reference herein to components, sheets, layers being “between” or “sandwiched between” other components, sheets, or layers, should not be read to exclude the presence of intervening components, sheets, or layers. Similarly, reference herein to a component, sheet, or layer being positioned “over” another component, sheet, or layers should not be read to exclude the presence of an intervening component, sheet, or layer.

For the purposes of describing and defining the present invention it is noted that the terms like “substantially,” “approximately,” and “about” are utilized herein to represent the inherent degree of uncertainty that may be attributed to any quantitative comparison, value, measurement, or other representation. The terms “substantially,” “approximately,” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A recreational vehicle comprising a chassis, at least one axle assembly, a vehicle body, and a slide out compartment, wherein:
the vehicle body comprises an interior space and a floor and is supported by the chassis;
the at least one axle assembly is coupled to the chassis and provides motive support to the chassis;
the slide out compartment is integrated with the vehicle body, is extendable to expand an interior volume of the vehicle body, and is retractable over a body-side edge of the floor of the vehicle body to reduce the interior volume of the vehicle body;
the slide out compartment comprises a slide out floor assembly comprising an impact resistant sheet, a core floor component, a weather resistant sheet, and an entry bevel;
the core floor component of the slide out floor assembly comprises an interior-facing surface and an exterior-facing surface and is sandwiched between the impact resistant sheet and the weather resistant sheet;
the entry bevel is positioned along an entry edge of the core floor component of the slide out compartment and comprises a leading edge, a transitional surface, an angled contact surface, a sheet concealment ridge, an exterior sheet accommodating surface, and an anchoring tail;
the transitional surface of the entry bevel extends from the leading edge of the entry bevel towards the interior-facing surface of the core floor component and lies in a common plane with the interior-facing surface of the core floor component;
the impact resistant sheet extends over the transitional surface of the entry bevel and the interior-facing surface of the core floor component;
the angled contact surface of the entry bevel extends from the leading edge of the entry bevel towards the exterior-facing surface of the core floor component;
the exterior sheet accommodating surface of the entry bevel extends from the sheet concealment ridge of the entry bevel towards the exterior-facing surface of the core floor component and is offset from the exterior-facing surface of the core floor component by a thickness dimension of the anchoring tail of the entry bevel;
the anchoring tail extends from, and lies in a common plane with, the exterior sheet accommodating surface of the entry bevel and is sandwiched between the core floor component and the weather resistant sheet; and
the weather resistant sheet extends over the exterior sheet accommodating surface of the entry bevel, the anchoring tail of the entry bevel, and the exterior-facing surface of the core floor component.

2. The recreational vehicle of claim 1, wherein the angled contact surface of the entry bevel is positioned to engage the body-side edge of the floor of the vehicle body as the slide out compartment is retracted from an extended position.

3. The recreational vehicle of claim 2, wherein the impact resistant sheet extending over the transitional surface of the entry bevel is positioned to lie in a common plane with the floor of the vehicle body when the slide out compartment is in the extended position.

4. The recreational vehicle of claim 1, wherein the angled contact surface of the entry bevel extends from the leading edge of the entry bevel to the sheet concealment ridge of the entry bevel.

5. The recreational vehicle of claim 1, wherein the angled contact surface of the entry bevel is supported via a contact support extending from the angled contact surface to the transitional surface of the entry bevel.

6. The recreational vehicle of claim 1, wherein a height of the sheet concealment ridge relative to the exterior sheet accommodating surface is greater than a thickness of the weather resistant sheet.

7. The recreational vehicle of claim 6, wherein the height of the sheet concealment ridge is less than about 1 millimeter greater than the thickness of the weather resistant sheet and the height of the sheet concealment ridge relative to the exterior sheet accommodating surface is less than 2 mm.

8. The recreational vehicle of claim 1, wherein the anchoring tail of the entry bevel extends from the exterior sheet accommodating surface and terminates at a tapered terminal portion.

9. The recreational vehicle of claim 8, wherein a thickness dimension of the anchoring tail, orthogonal to a major face of the weather resistant sheet, is less than respective thickness dimensions of the transitional surface of the entry bevel in the same direction.

10. The recreational vehicle of claim 8, wherein:
the anchoring tail defines a tail length A from the exterior sheet accommodating surface to the tapered terminal portion;
the entry bevel defines a body length B along a dimension parallel to the transitional surface of the entry bevel, the body length B encompassing a transitional surface length C and the tail length A of the anchoring tail;
the tail length A is at least about 25% of the body length B.

11. The recreational vehicle of claim 10, wherein the tail length A is less than the transitional surface length C.

12. The recreational vehicle of claim 11, wherein:
the exterior sheet accommodating surface defines a surface length D along a dimension parallel to the transitional surface of the entry bevel; and
the tail length A is greater than the surface length D.

13. The recreational vehicle of claim 12, wherein the tail length A and the surface length D, combined, are between about 40% and about 60% of the body length B.

14. The recreational vehicle of claim 1, wherein the anchoring tail of the entry bevel lies in a plane that is parallel to the transitional surface of the entry bevel.

15. The recreational vehicle of claim 1, wherein the anchoring tail is secured to the exterior-facing surface of the core floor component.

16. The recreational vehicle of claim 1, wherein the entry bevel comprises an abutment surface that abuts the entry edge of the core floor component and the abutment surface is welded to the entry edge of the core floor component.

17. The recreational vehicle of claim 1, wherein the leading edge of the entry bevel is truncated to form a leading edge surface extending from the transitional surface to the angled contact surface.

18. The recreational vehicle of claim 1, wherein the slide out floor assembly further comprises a planar strength member sandwiched between the weather resistant sheet and the core floor component.

19. The recreational vehicle of claim 18, wherein the planar strength member extends over a skeletal framework, a plurality of foam core inserts, and a plurality of contained framework cells of the core floor component.

20. The recreational vehicle of claim 18, wherein the planar strength member extends over the exterior-facing surface of the core floor component and the anchoring tail of the entry bevel.

21. The recreational vehicle of claim 1, wherein the impact resistant sheet extends from the leading edge of the entry bevel, over the transitional surface of the entry bevel, and over the interior-facing surface of the core floor component.

22. The recreational vehicle of claim 1, wherein the weather resistant sheet extends from the sheet concealment ridge and over the exterior-facing surface of the core floor component.

23. A slide out floor assembly comprising an impact resistant sheet, a core floor component, a weather resistant sheet, and an entry bevel, wherein:
the core floor component of the slide out floor assembly comprises an interior-facing surface and an exterior-facing surface and is sandwiched between the impact resistant sheet and the weather resistant sheet;
the entry bevel is positioned along an entry edge of the core floor component and comprises a leading edge, a transitional surface, an angled contact surface, a sheet concealment ridge, an exterior sheet accommodating surface, and an anchoring tail;
the transitional surface of the entry bevel extends from the leading edge of the entry bevel towards the interior-facing surface of the core floor component and lies in a common plane with the interior-facing surface of the core floor component;
the impact resistant sheet extends over the transitional surface of the entry bevel and the interior-facing surface of the core floor component;
the angled contact surface of the entry bevel extends from the leading edge of the entry bevel towards the exterior-facing surface of the core floor component;
the exterior sheet accommodating surface of the entry bevel extends from the sheet concealment ridge of the entry bevel towards the exterior-facing surface of the core floor component and is offset from the exterior-facing surface of the core floor component by a thickness dimension of the anchoring tail of the entry bevel;
the anchoring tail extends from, and lies in a common plane with, the exterior sheet accommodating surface of the entry bevel and is sandwiched between the core floor component and the weather resistant sheet; and
the weather resistant sheet extends over the exterior sheet accommodating surface of the entry bevel, the anchoring tail of the entry bevel, and the exterior-facing surface of the core floor component.

24. A recreational vehicle comprising a slide out compartment comprising a core floor component, a weather resistant sheet, and an entry bevel, wherein:
the core floor component comprises an interior-facing surface and an exterior-facing surface and the weather resistant sheet is positioned over the exterior-facing surface of the core floor component;
the entry bevel is positioned along an entry edge of the core floor component and comprises a leading edge, a transitional surface, an angled contact surface, a sheet concealment ridge, and an anchoring tail;
the transitional surface of the entry bevel extends from the leading edge of the entry bevel towards the interior-facing surface of the core floor component;
the angled contact surface of the entry bevel extends from the leading edge of the entry bevel towards the exterior-facing surface of the core floor component;
the anchoring tail is sandwiched between the core floor component and the weather resistant sheet; and
the weather resistant sheet extends from the sheet concealment ridge, over the anchoring tail of the entry bevel and the exterior-facing surface of the core floor component.

25. A recreational vehicle comprising a chassis, at least one axle assembly, a vehicle body, and a composite floor, wherein:
the vehicle body and the composite floor are supported by the chassis;
the axle assembly is coupled to the chassis and provides motive support to the chassis;
the composite floor comprises an impact resistant sheet, a core floor component, a planar strength member, and a weather resistant sheet;
the core floor component comprises an interior-facing surface, an exterior-facing surface, a skeletal framework, a plurality of foam core inserts, and a plurality of contained framework cells, wherein the core floor component is sandwiched between the impact resistant sheet and the planar strength member;
the weather resistant sheet is positioned on an exterior surface of the planar strength member;
each contained framework cell is bounded volumetrically by frame segments of a closed frame section, portions of the impact resistant sheet, and portions of the planar strength member; and
each contained framework cell is packed with one or more of the foam core inserts and the foam core inserts within each cell collectively occupy a substantial entirety of the contained framework cell.

26. The recreational vehicle of claim 25, wherein the planar strength member extends over the exterior-facing surface of the core floor component.
